(19) United States
(12) Patent Application Publication
(10) Pub. No.: US 2008/0161110 A1
(43) Pub. Date: Jul. 3, 2008

(54) IN-ROOM GAMING

(76) Inventors: Steven Mark Campbell, Las Vegas, NV (US); Chris Tyson, Austin, TX (US); Terry Tyndall, Wilmington, NC (US)

Correspondence Address: QUARLES & BRADY LLP, RENAISSANCE ONE, TWO NORTH CENTRAL AVENUE, PHOENIX, AZ, 85004-2391, US

(21) Appl. No.: 11/877,915

(22) Filed: Oct. 24, 2007

Related U.S. Application Data
(60) Provisional application No. 60/855,553, filed on Oct. 31, 2006.

(51) Int. Cl. A63F 13/00

(52) U.S. Cl. 463/40

(57) ABSTRACT

An interactive system allows gambling in hotel rooms (or other remote locations that are part of a cable TV system) using a Video On Demand (VOD) system interfaced with circuit boards used to operated a corresponding plurality video gaming machines, including video slots and video card games. Player checking in as well as checking out processes are facilitated through the VOD system which is operated as a hub or a portal. Existing VOD system cabling to the hotel room can be used to connect up the gaming machines circuit boards to the VOD system, thereby allowing play any place in the hospitality environment where such cabling is in communication with responding TV sets.

### RELATED APPLICATIONS

This application claims priority to and the benefit of U.S. Provisional Application Serial No. 60/855,553, filed on Oct. 31, 2006, titled “IN-ROOM/REMOTE GAMING SYSTEM”, the entire contents of which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### TECHNICAL FIELD

The present invention relates generally to playing interactive video games in a hospitality environment, and more specifically to interactive casino gambling in a hospitality environment.

### BACKGROUND

It would be an advance in the hospitality industry, though as yet unfulfilled, to enable hotel and/or casino guests to play actual casino games, the same as on the casino floor, only in a hotel room or any location where an audiovisual communication link passes (wired television cable, wireless connect, etc.). Such a location could include poolside cabanas, restaurants or even on the casino floor, or other areas where a TV/movie system (also web-based) for the hotel room would be operating (e.g.; hotels; casinos; cruise ships, etc.), where the movie system may also be known as a Video On Demand (VOD) system.

### BRIEF DESCRIPTION OF THE DRAWINGS

FIGS. 1-26 include full and partial views of exemplary user interface screens, and related flow charts and diagrams, for an in-room/remote gaming system as described with respect to various implementations thereof.

FIG. 1: Remote and example TV image; Picture of specially designed remote labeled to help playing games. An example of what the screen looks like when playing

FIG. 2: In-Room/Remote Overview; Top level diagram of the entire system;

FIG. 3: Game Rack Overview: Top level diagram of the Game rack. Shows what components are contained in the rack;

FIG. 4: Movie System-Traffic Manager Connection; Diagram of connection between the Movie System (VOD) and the Traffic Manager. This can be either serial or Ethernet connection;

FIG. 5: Traffic Manager Overview: Diagram showing how the Traffic Manager communicates with the Game Machines;

FIG. 6: Game Box Overview; Diagram explaining the communications between the Game Machine components with the Game Computer and the Traffic Manager;

FIG. 7: Point Of Sale: High level diagram of the POS and its components;

FIG. 8: POS Main Screen Example: POS program showing the Main Screen;

FIG. 8a: POS-Main Screen Status Button Explanation −1; Explanation of Real Time Data on Status Button;

FIG. 8b: POS-Main Screen Status Button Explanation −2; Explanation of Real Time Data on Status Button;

FIG. 8c: POS-Main Screen Status Button Explanation −3; Explanation of Real Time Data on Status Button;

FIG. 8d: POS-Main Screen Status Button Explanation −4; Explanation of Real Time Data on Status Button;

FIG. 9: POS-Game Status Report; Status Report Screen;

FIG. 9a: POS-Game Status Report Explanation; Explanation of Real Time Data on Status Report Screen;

FIG. 10: POS-Check-In/Enroll Screen; POS Screen showing the Check-In/Enroll Screen;

FIG. 11: Check-In/Enroll Flow Diagram;

FIG. 12: POS-Add Money Screen; POS Screen showing the Add Money Screen;

FIG. 13: POS-Inquiry Screen; POS Screen showing the Inquiry Screen;

FIG. 14: POS-Employee Setup Screen; POS Screen showing the Employee Setup Screen;

FIG. 15: TV—Not enrolled; TV screen that is shown if a player not enrolled selects the gaming system from the movie menu;

FIG. 16: TV—No money in account; TV screen that is shown if a player is enrolled but has no money in their player account;

FIG. 17: TV—PIN password screen; TV screen that is shown for PIN password entry;

FIG. 18: TV—Wrong password screen; TV screen that is shown for the wrong password entry;

FIG. 19: TV—No Activity Screen; TV screen that is shown when there is no activity after the configurable time;

FIG. 20: TV—Middle of game; TV screen that is shown when a player tries to exit in the middle of a game;

FIG. 21: TV—Exiting game; TV screen that shows how much money is left in the account when exiting the system;

FIG. 22: Game Interface Screen Flow Chart; Flow chart of game play, including both screens from the game machine and the game computer;

FIG. 23: POS—Check-out screen; POS screen showing the Check-out screen;

FIG. 24: Interface Board Communication; Diagram showing how the Interface Board communicates with the system;

FIG. 25: Check-Out Flow Diagram; Overview of the Check-out process;

FIG. 26: System Overview; Technical drawing showing how the system operates.

### SUMMARY

An interactive system allows people to gamble on any TV location that the movie/web based system is connected to, including hotels/casino/ships/bars/pools/cabanas. The movie system may also be called a Video On Demand (VOD) system. This is not the same as going to an internet casino; this would be actual casino gaming using the movie/web based system, TV and a remote device. The remote device may contain biometrics for player authentication, as well as a card reading device to use a player tracking card or room card. The remote device could also be two-way communications, while also supporting game audio and/or visual feedback such as sounds, lights, vibrations that emulate the user experience of real casino floor game play including connections interoperable with wide area progressive jackpots. Actual Class II and Class III machines used today and downloadable/server-based machines in the future would be used. The front desk/casino/kiosk (automated or non-automated) would place money into the customer account for play. The checking in process as well as the checking out process is unique. The movie system could also be used as a portal in the process.

Current approved Class II and Class III slot machines are used. These are the same games as on the floor. This is not internet casino/software; this is internal to the casino/hotel (Intranet). When future downloadable/server based gaming comes out, they can be easily added and/or mixed. The current movie system will be used to allow the play to any location the movie system is operating. This will allow only a few games to cover an entire area, since many people can try to connect to a single machine. Once a machine is in play, no other player can use the machine. Hotel/casinos/ships are already wired with the movie system using either coaxial cable or Ethernet. By connecting to the head-end of the movie system, we will be able to use any TV for the picture. The movie system will send the TV remote buttons to our system, and we will interpret that to the correct button on the game. To play, an account is opened by the player.

The cost would be low since all the cabling to all TV's is already in place. This includes using coaxial cable as well as Ethernet cable. Connecting up to the VOD will allow play anyplace in the hotel/casino where these TV sets are located.

The In-Room/Remote Gaming System is an exciting new product which allows a customer to play video game machines in a hotel room, or any location the TV/movie system is operating. The system connects up to any Video On Demand (VOD) and allows a person to use the TV remote to play. A large TV remote has been designed for easier use.

The In-Room/Remote Gaming System is not an internet casino site. The machines used in this system are the same game machines, (class II and class III), found on casino floors throughout the world, and will work with future generation system based and downloadable gaming. Game manufacturers have spent millions of dollars developing and approving these games. The In-Room/Remote Gaming system takes these machines and uses a proprietary technology to allow the VOD system to communicate with them.

When a customer checks in, he types in his own unique PIN password at the front desk or kiosk, which allows access to the In-Room/Remote Gaming System. A player account is opened, allowing for play while at the location. At check-out, the customer enters the PIN password at the front desk for authentication, and the player account is then paid or credited, although these processes could also use biometrics or digital photos to authenticate and/or verify the user's access.

### DETAILED DESCRIPTION

In-Room/Remote Gaming

The In-Room/Remote Gaming System is an exciting new product which allows a customer to play video game machines in a hotel room or any location that the movie system is connected to. The system connects up to any hotel Video On Demand (VOD) or web-base TV system and allows a person to use a remote control device to play. A large TV remote has been designed for easier use.

The In-Room/Remote Gaming System is not an internet casino site. The machines used in this system are the same game machines, (class II and class III), found on casino floors throughout the world, and will work with future generation system based and downloadable gaming. Game manufacturers have spent millions of dollars developing and approving these games. The In-Room/Remote Gaming system takes these machines and uses a proprietary technology to allow the hotel VOD system to communicate with them.

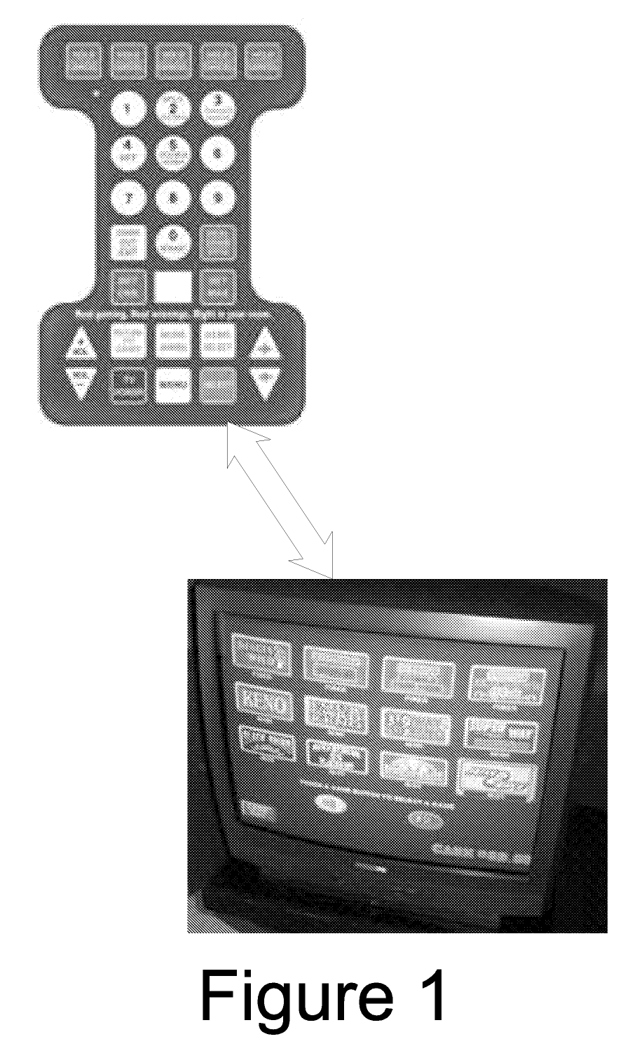

When a customer checks into the hotel, he types in his own unique PIN password at the front desk or kiosk, which allows access to the In-Room/Remote Gaming System. A player account is opened, allowing for play. At check-out, the customer enters the PIN password at the front desk for authentication, and the player account is then paid or credited. See FIG. 1.

System Overview

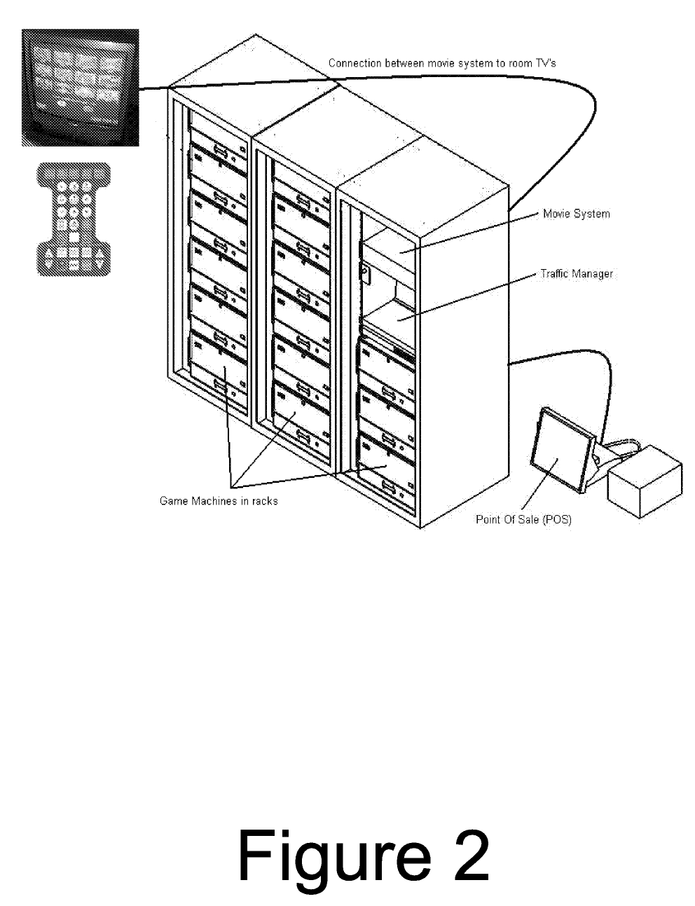

See FIG. 2 for an example of the entire system. The following parts are included:

Rack mounted gaming machines. Each machine is built into a small enclosure that can be placed into a rack enclosure for security.

Traffic Manager. Manages the game machines while speaking to the movie system.

Point Of Sale (POS). Used for customer check-in, check-out, adding money and report generation.

Movie System. Can be part of the rack or located separately. The movie system used by the hotel/casino/ship.

All parts will now be broken down and explained.

Technical Specifications

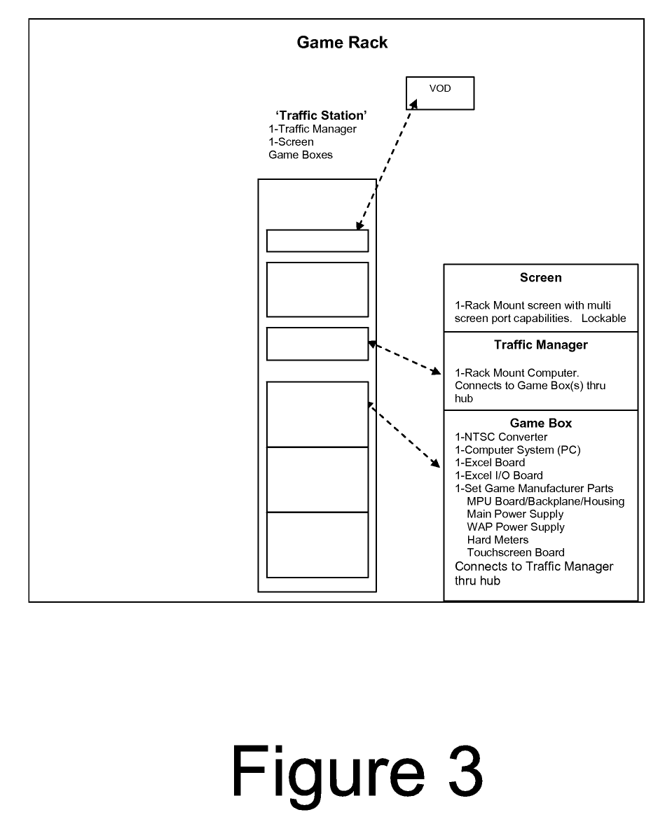

There are 5 blocks that describe the system. The game machine (such as slots or poker), the game Interface Board, the Traffic Manager, the Point Of Sale, and the Video On Demand (VOD) system. The VOD system is already in place in the hotels/casinos/ships. The system is designed in a modular system, built in racks for easy installation in any secured room, called the slot station. See FIG. 3 for a breakdown of the system.

(1) Traffic Manager

The traffic manager is a PC, running any type of operating system, including Windows, MacOS, Linux, Unix, etc. The traffic manager is connected to the VOD system by way of a RS232 connection, (can also be Ethernet). It is the job of the Traffic Manager to listen for new users from the VOD system. Once the new user (room number) has established a connection, the VOD system sends the audio and video of a given video gaming machine to that room. That room now has exclusive control of that video gaming machine via the TV IR remote control. Each game button can be simulated on the IR remote device. The Traffic Manager, Game Box(s), and POS(s) are on a private local network using TCP/IP.

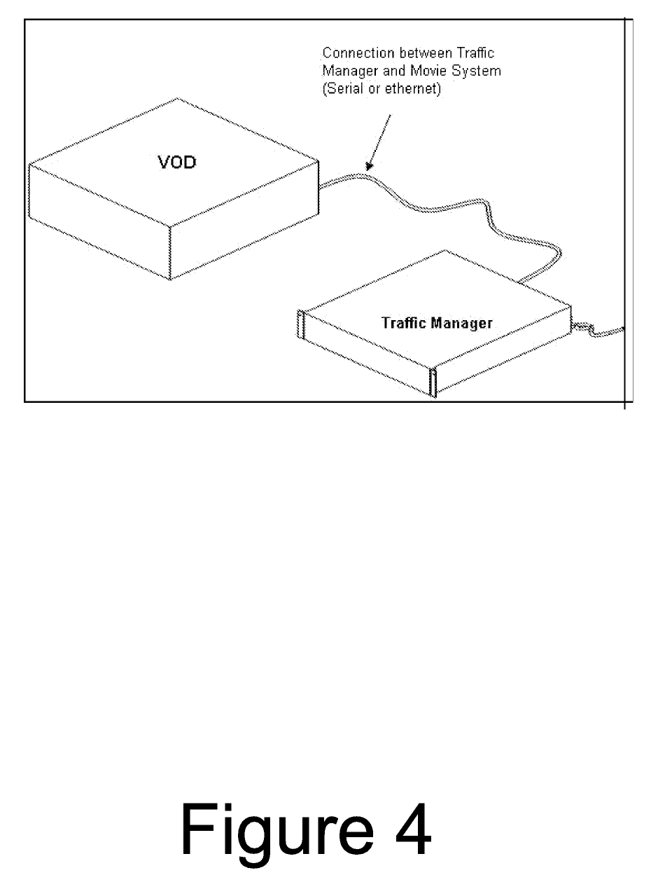

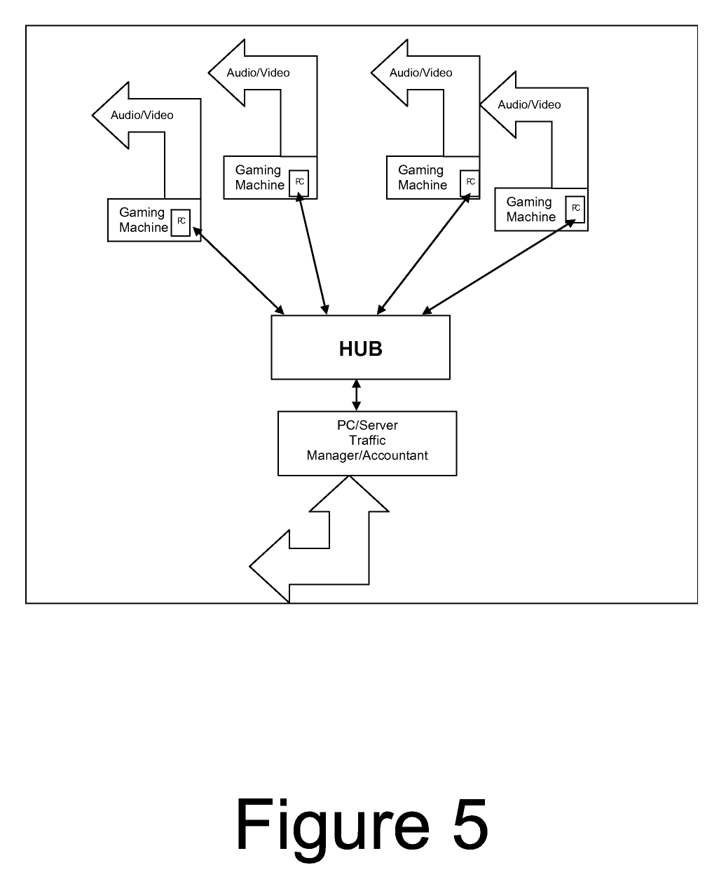

The traffic manager keeps track of all resources, and tells the VOD if no machines are available. The VOD sends only room number and key strokes, and waits for the traffic manager to give the results back to show on the appropriate room TV. See FIG. 4 to see how the Traffic Manager connects to the VOD

The Traffic Manager can handle multiple game boxes, as shown in FIG. 5.

(2) Game Machine (Game Box)

The Game Box contains the following:

Game Box Computer

Game Machine Components:

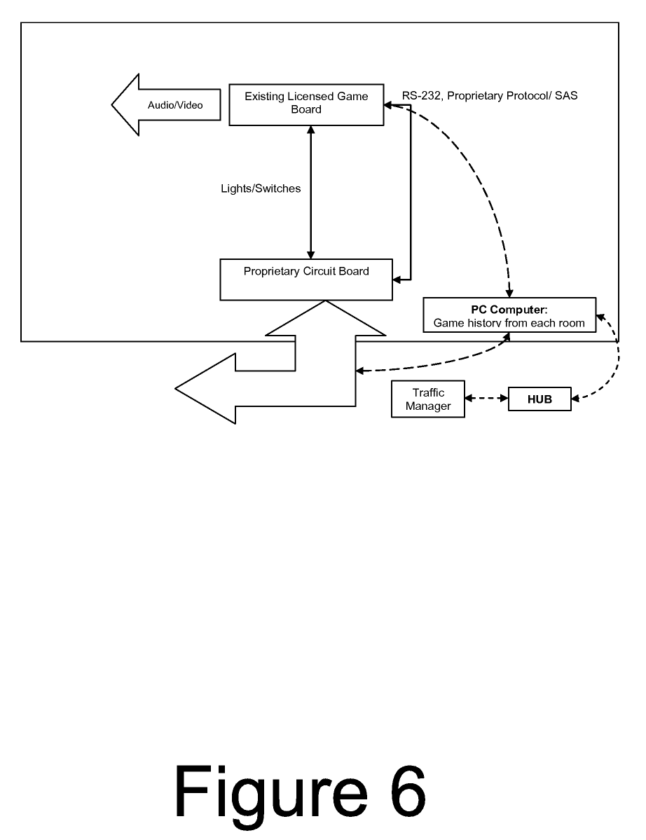

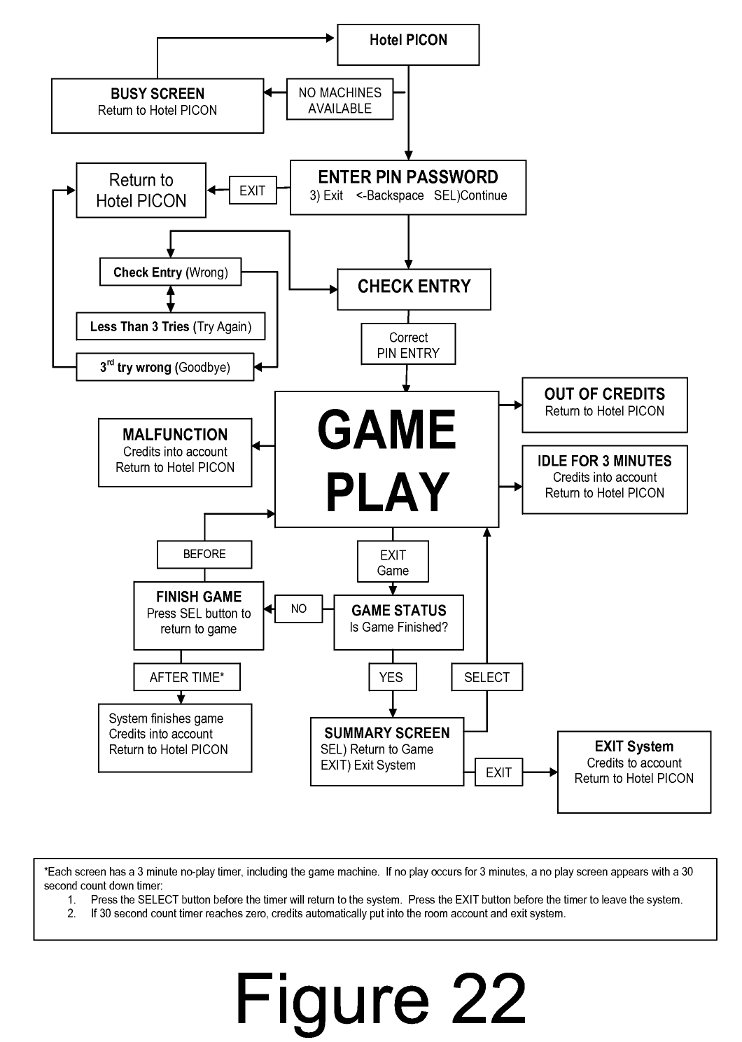

Each game box contains a small computer which uses a proprietary protocol as a host to the Interface Board, and is used to run the movie screen software program, run credit card transactions via the Internet (where regulations allow), and keep track of game machine data, such as all transaction history, which includes play from each room in the hotel which connects to a particular Game Box, as shown in FIG. 6. The screens are run by a program labeled ‘Game_Interface.exe’, which is placed in the ‘Start-Up’ under Windows to automatically run when the computer is turned on. (See FIG. 22 for a complete flow diagram of the game screens).

The program does the following:

1. Runs all screens in any language necessary.

2. Keeps track of money in the room account.

3. Switches between the computer screen and game machine screen.

4. Keeps a history of game play on the local hard drive.

5. Process credit card transactions via the Internet, using Papal, etc.

When the power switch to the game box is turned on, the game box computer will automatically start. The ‘Game_Interface’ program is automatically loaded, waiting for game play to begin. When a game is picked the ‘Game_Interface’ program is responsible for showing screens to allow the customer to interact. Screens samples with explanations follow:

Screens (contained on game box computer)

The following pages will explain sample screens as well as unique features, including:

Automatic PIN password checking

Automatic no play timer which removes customer and places money into room account

Automatic checking to ensure a game is finished if a customer tries exiting

Automatic finishing of a game if the no play timer happens

After the Picon is picked, all menus forward are controlled by the game box computer.

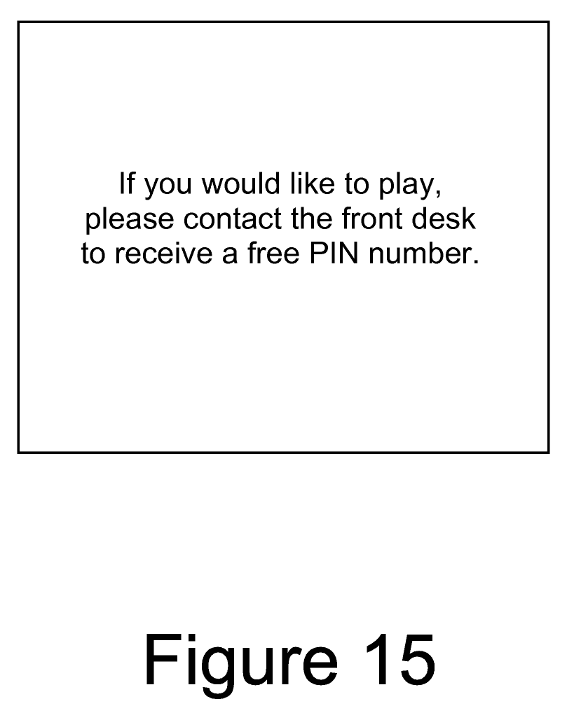

If the customer does not sign up for a PIN password at the front desk during Check-in, the screen shown by FIG. 15 will appear. The VOD ‘Welcome’ channel will appear in 30 seconds.

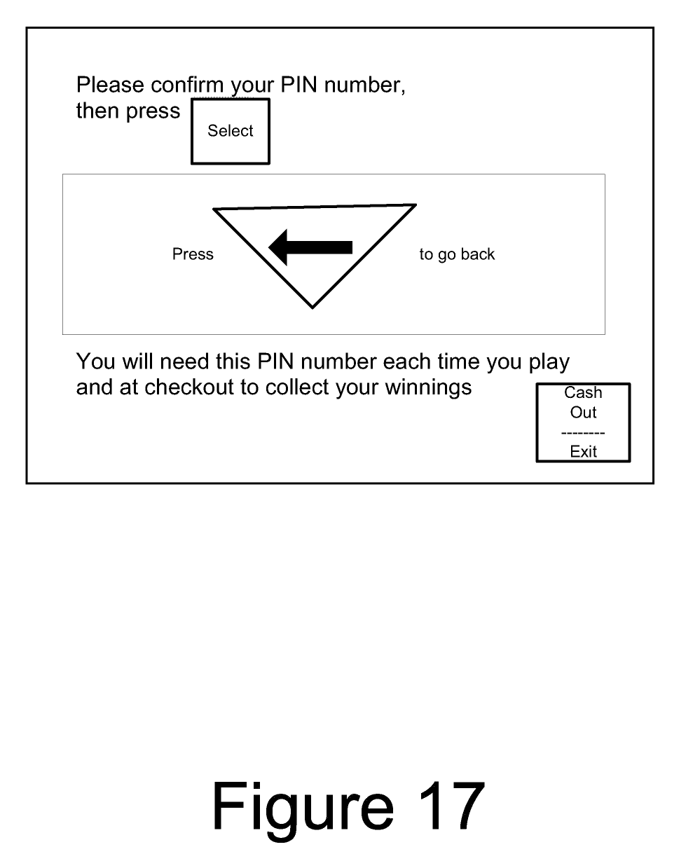

PIN Entry, FIG. 17

At Check-in, the customer creates his own unique PIN password on the PIN Pad. This PIN password will not work if used in another room of the hotel. Enter the PIN password and press the ‘SELECT’ button. Use the ‘→’ button to erase a wrong number on the screen.

An automatic timer will return the customer to the Welcome channel in three minutes if no button is pressed.

At any time the customer can leave the In-Room/Remote Gaming System and return to the Welcome channel by press the ‘CASH OUT/EXIT’ button on the remote. Once a PIN password is entered and the ‘SELECT’ button is pressed, the In-Room/Remote Gaming System checks this PIN password with the correct PIN password/Room number in the database.

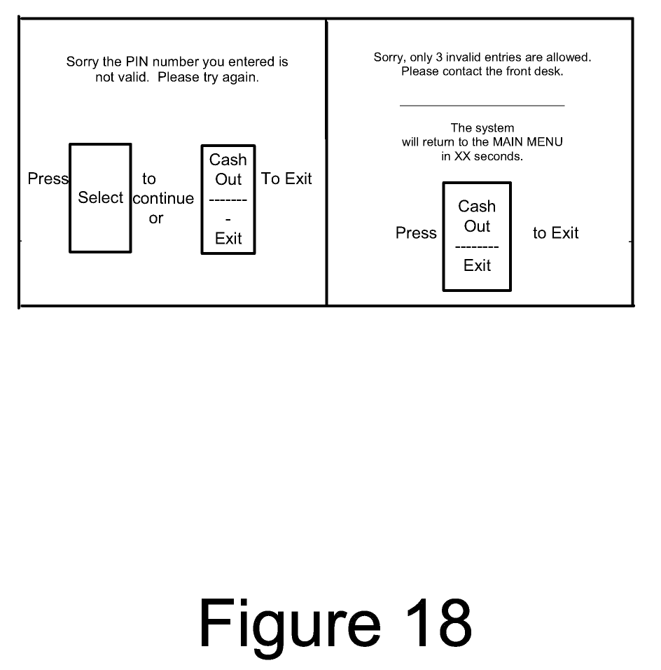

If a wrong PIN password is entered the screen in FIG. 18 appears. The customer has 3 tries to type in the correct PIN password. Pressing the ‘CASH OUT/EXIT’ on the remote will return the customer to the Welcome channel. Press the ‘RETURN’ button to enter the PIN password again.

If nothing is pressed, the automatic timer will return to the VOD ‘Welcome’ channel.

If the wrong PIN password is entered for a third time, the screen in FIG. 18 appears. The customer will be returned to the Welcome channel.

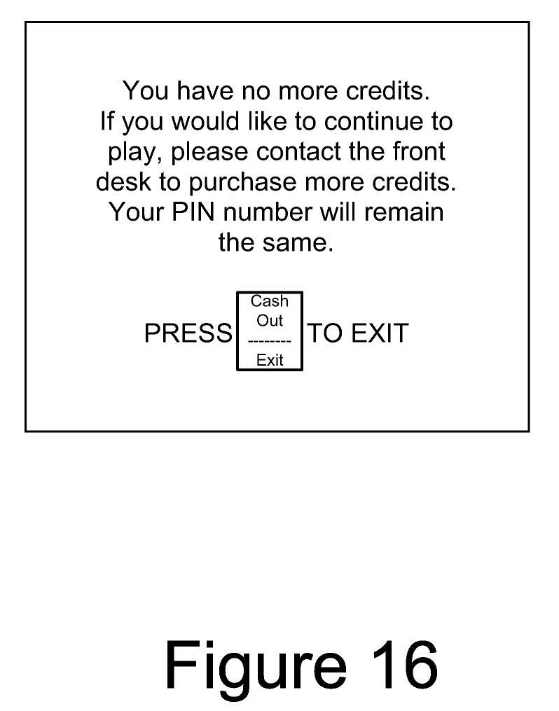

Once the correct PIN password has been verified for the room, the system checks the database for any money in the account. If there is no money in the account, the screen in FIG. 16 appears. The front desk will explain how more money can be entered into your account if you wish to continue playing.

Once the correct PIN password is entered and money is in the room account, a real game machine will with the proper amount of credit will appear, using EFT. The system uses real game machines built by game manufacturers found throughout the world, the same as those on the casino floor. These are not internet casino games.

The picture in FIG. 1 is an example of what a multi-game machine may look like on the TV.

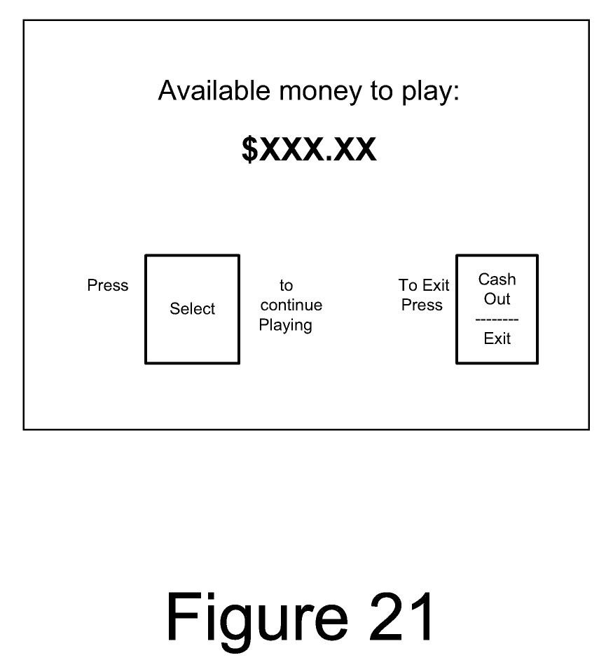

Account Summary, FIG. 21

This gives a summary of money at begin of play until the ‘CASH OUT/EXIT’ button was pressed. Pressing the ‘SELECT’ button will return you to the game machine, while pressing ‘CASH OUT/EXIT’ will remove you from the In-Room/Remote Gaming System and back to the VOD ‘Welcome’ screen. Returning to the VOD ‘Welcome’ screen will place any credits into the correct account, using EFT.

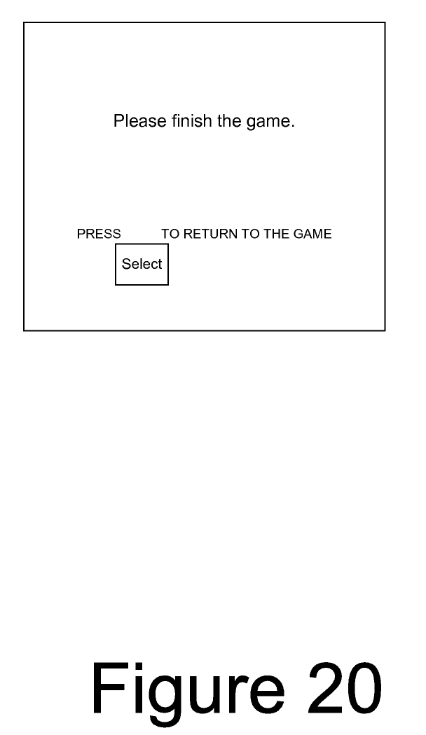

When the ‘CASH OUT/EXIT’ button is pressed, the In-Room/Remote Gaming System interrogates the game machine to make sure the current game is finished. The screen in FIG. 20 will appear if play has not finished. At this time press the ‘SELECT’ button to return to the game machine and finish play.

If no button is pressed in a three minute time frame, the system will automatically finish the hand by pressing the ‘HIT’ button. Any credits will be placed into the room account and the Welcome channel will return.

If, during game play, all credits on the machine are lost then the screen shown in FIG. 16 appears.

At this time more credits must be placed on the room account at the Point Of Sale.

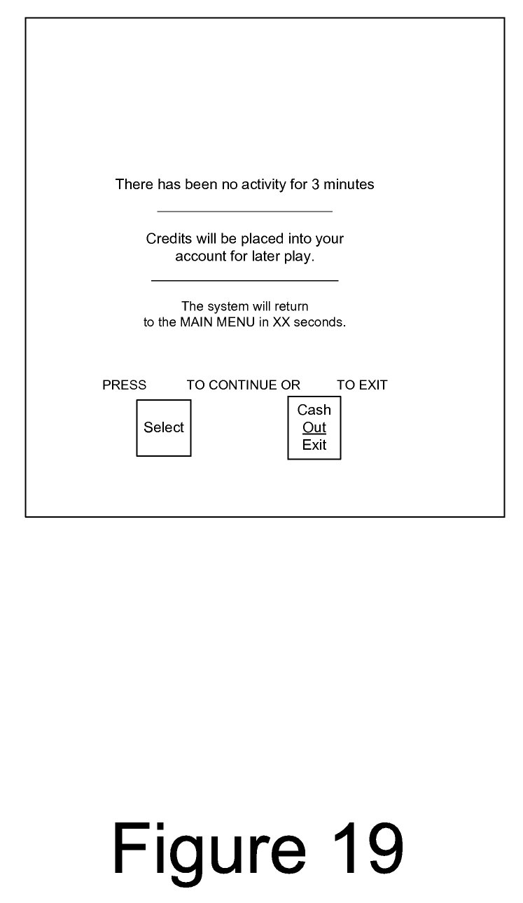

Automatic Timer, FIG. 19

The system contains an automatic no play timer. If no buttons are pressed during this time, the screen above appears. The customer has 30 seconds to press the SELECT button to continue play or the CASH OUT/EXIT button to end play. If nothing is pressed, any remaining credits are placed into the room account for later play.

(3) Interface Board

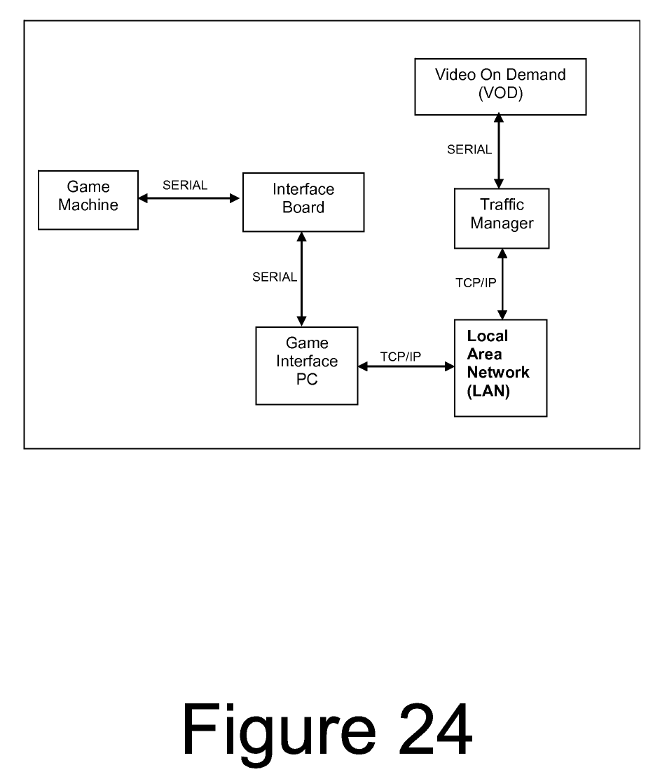

The interface board connects the video gaming machine to the Game Interface PC, and is contained in the game box. It is made up of relays allowing for remote control of the switches, sensors for reading lights that are on (from the video gaming machine), and Non-Volatile RAM (NVRAM) for storing transactions. All of these features are well suited for compliance and future expansion (like Player Tracking, Wide Area Progressive jackpots connection and remote monitoring). See FIG. 24 for the Interface Board Communication diagram.

The best feature on this board is the ability to communicate in SAS protocol. SAS also allows the hotel casino to track payout performance of individual games and play. Typical meters such as Coin In, Coin Out, Games Played, Jackpot are just a few that can be monitored in real time by the interface board.

The Interface Board can interface to existing player tracking systems for accruing points, using existing an existing player tracking card. When a player checks in, he enters his player tracking card and the Interface Board then keeps track of this information.

In another implementation a remote control used by a player can feature a “Current Points” button or switch. When engaged, this button causes the TV or visual display to flash a computer generated screen showing the current points attributed to the player and any messages that the player tracking system would normally show on a secondary display device of a real casino floor slot of video card game machine. For example “Welcome John Smith to Fiesta Casino; your current points are 23,200”. This message is read from the existing player tracking system and interpreted for rendering upon the computer generated screen. The player, for instance, can press the button again to return to game. On this same display screen, other animated advertising could be added to generate revenue. For instance, a player can redeem their player points right in the room using this same screen for movie tickets, cigarettes, etc. For example: press 1 for phantom tickets, press 2 for buffet, etc., (quantity and confirmation screens to follow).

In yet another implementation, a player tracking interface can ensure that a player's tracking card gets swiped one time at player check-in and that the data so captured can be used in reference to the player's room. The card-in and card-out processes are both simulated by an excel board interface to give the same effect to the player tracking system as if there processes were conducted on a floor game of a casino

The Interface Board contains a Motorola 68HC12 with two UARTs. The first UART is converted to a RS232 or RS422 standard depending on the hardware interface. The primary function of this port is SAS communication, which is a 9 bit, protocol that the 68HC12 is well suited for.

The second port is the host connection that has our proprietary protocol that controls all functions on the 68HC12 which includes toggling the onboard 12 relays, reads 12 light states and transfers SAS information to the host.

Video to NTSC conversion is done using the FocusInfo FS400 Video Conversion chip. This changes the gaming video into NTSC, which is then handed off to the VOD system.

An A/B switch for both audio and video is used to allow the Game Interface PC to switch between the computer audio/video and the gaming machine audio/video.

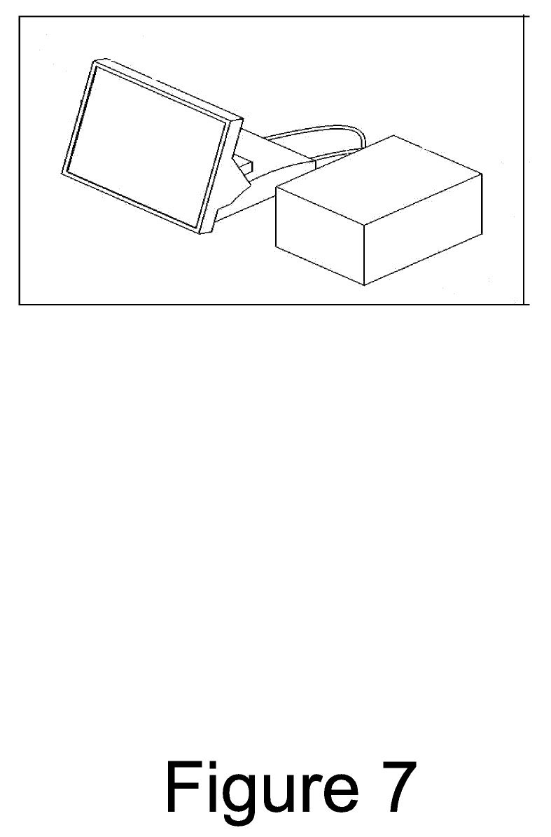

(4) Point Of Sale (POS), FIG. 7

The POS communicates with the database, allowing money to be entered and removed from the different room accounts of the hotel. Various reports can be printed. The POS includes the following equipment, as shown in FIG. 7:

POS computer

The POS software program is located on this computer. This program is used to communicate with the database, Traffic Manager, and game boxes.

Printer

Used to print reports, including checkin and checkout paperwork.

PINpad Device

Allows the entry of a unique PIN password for a room. This is done using either a keyboard, numeric keypad (tethered/wireless), touchscreen (resistive, capacitive, or proximity), TV remote, or any other device that can be used to enter this value. The system can take the first entry, or ask the customer to enter again for verification.

Card Reader

A room key or player tracking card can be used, since the system can be connected to both the casino accounting system, player tracking system, as well as the hotel system. A proprietary player tracking/game accounting system can also be used. The player tracking card can also be used for point redemption.

The POS contains the POS program with sample screens:

Main Screen

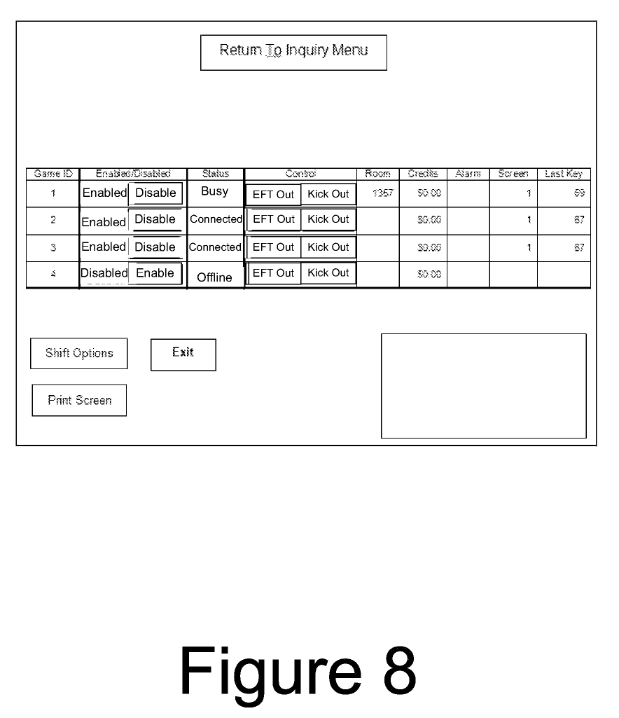

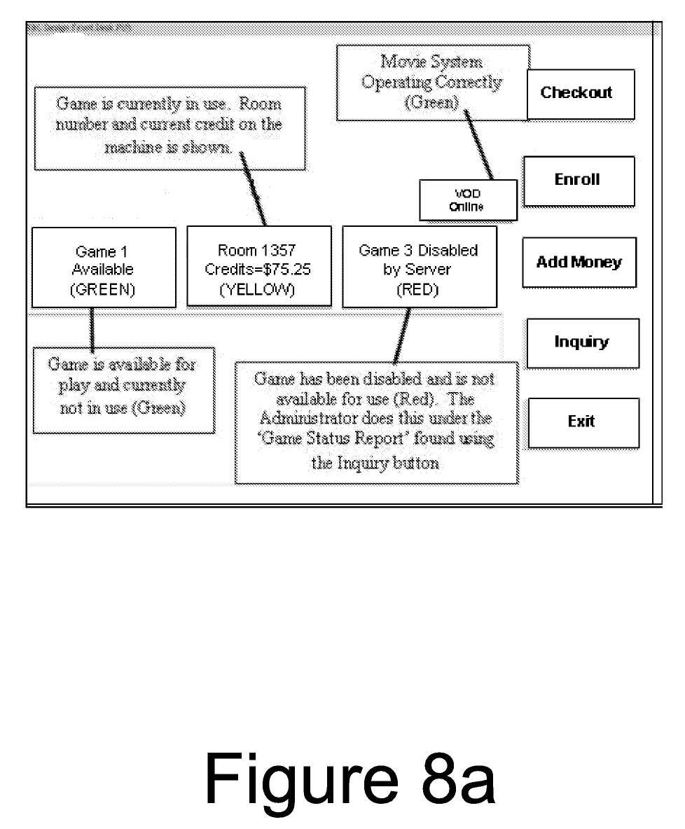

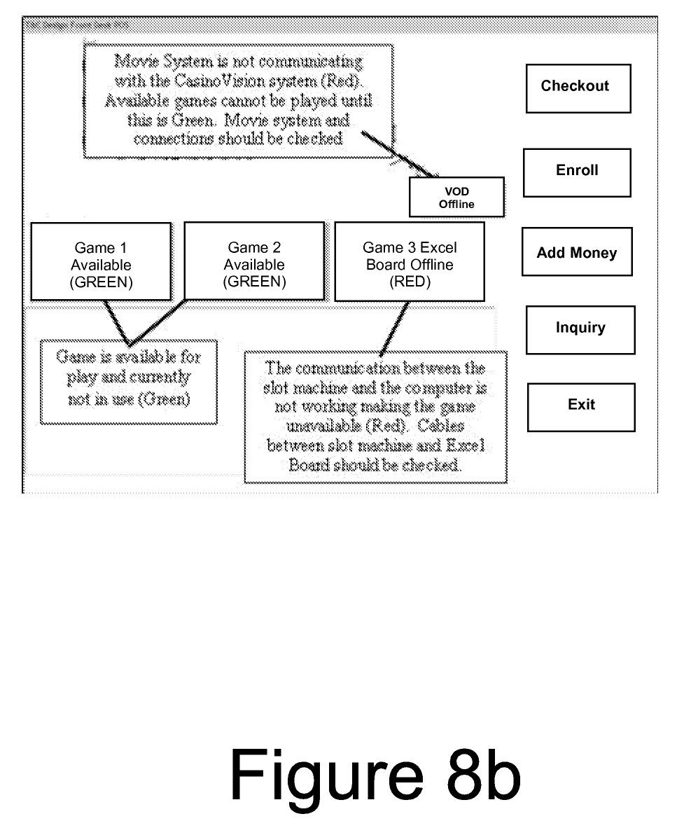

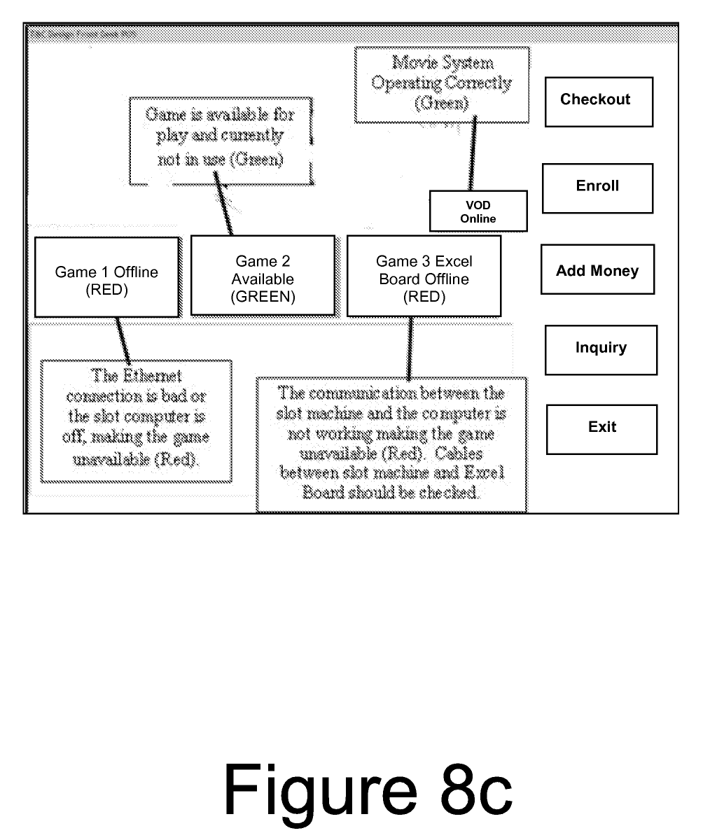

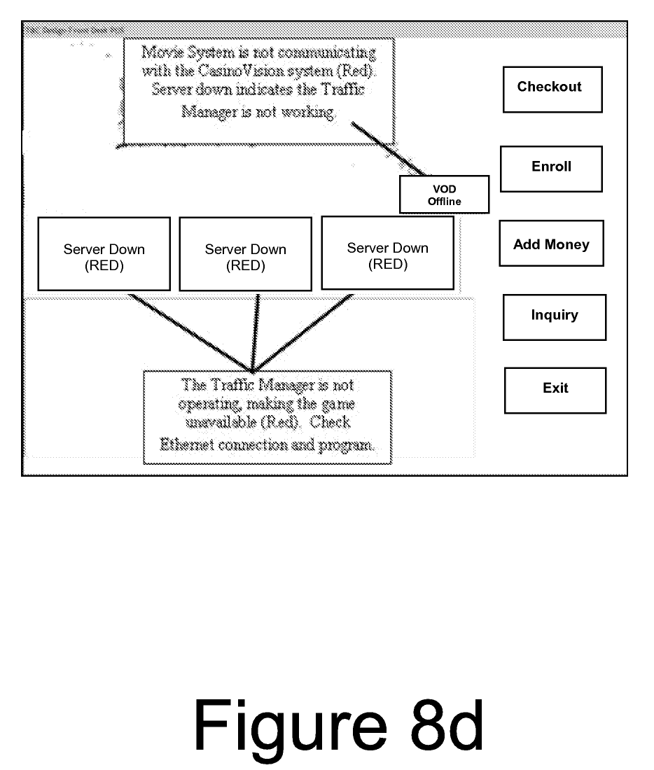

The computer used to run the POS program does not have a keyboard or mouse, the screen buttons are pressed to make the program operate. The main screen of the front Desk POS can be seen in FIG. 8, with the following unique features:

Real time movie system status (working/not working)

Real time status of games, including
Room currently using machine
Room balance
Meter readings

The POS Main Screen has three main areas on the screen:

1. Game Machine/Movie Status

Shows the status of each game machine and movie system

2. Buttons.

Used for the different functions of the program.

3. Help window

Shows explanations during program use.

Status Buttons (Real Time), FIG. 8a-FIG. 8d

The buttons display the status of the available game machines as well as the movie system. They are color coded for easy readability, and if pressed with show real time meter readings. Pressing a game status button will display real time meter readings, as well as current room information. See FIG. 8a-FIG. 8d to see these possibilities.

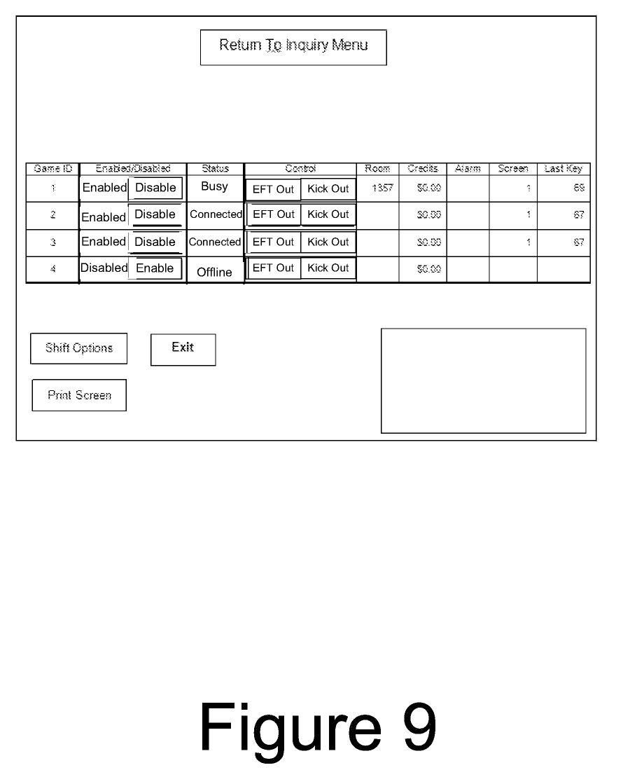

Game Status Report (Real Time), FIG. 9-FIG. 9a

The ‘Game Status Report’ shows the status of all games in the system. The status of a game is as follows:

Busy—Yellow. The game is in use

Out—Red. The game is currently off

Available—Green. The game is available for play

(5) Movie System (VOD)

The system works with all current movie systems and web-based systems operating world wide, including HN, nSTREAMS, Lodgenet, SeaChange, OCV, and nxTV. The movie system is used to connect the In-Room/Remote network to all rooms. A menu screen will be shown which has ‘In-Room/Remote Gaming’ as a choice. When the customer makes this selection with the remote, the movie system communicates to the In-Room/Remote system that a room would like to play. The Traffic Manager makes sure this room has an In-Room/Remote account and if a machine is available. If both are true, the room is taken to a game machine to enter their unique PIN password.

Technical Overview Of System

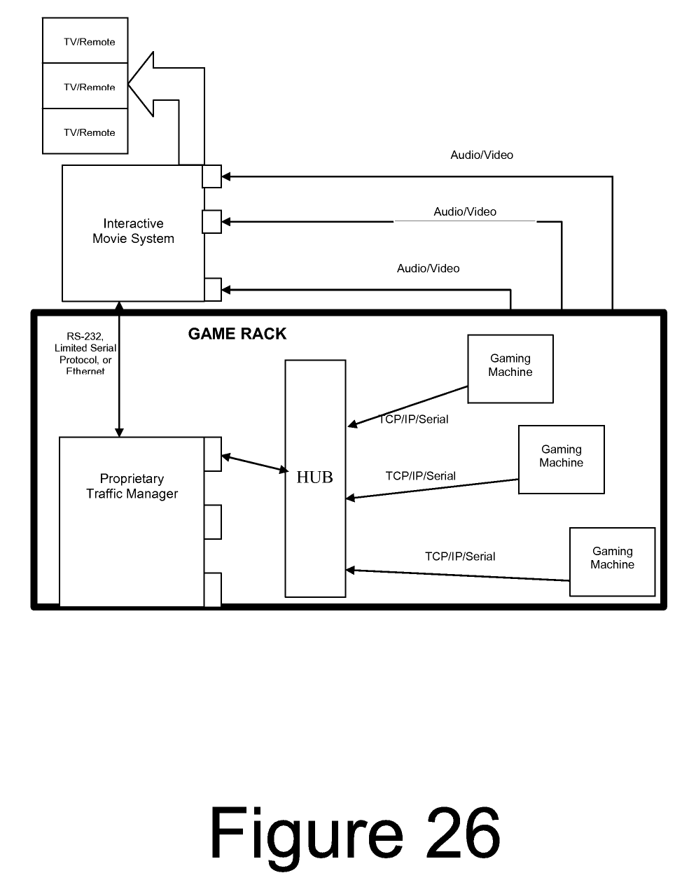

See FIG. 26 for a technical overview diagram, and FIG. 22 for a screen flow diagram.

Customer Check-in(Enroll) and Check Out

Customer Check-in:

Customer Check-in and check out cannot be performed by the administrator.

Customer checks into front desk, is asked about playing In-Room/Remote Gaming.

He accepts, and following occurs:
Front desk will either place playing amount on credit card or ask for cash deposit.
Front desk goes to CV POS, (there will be two locations of this):
   Enters Employee ID and Employee PIN password
      Enters Room Number
      Enters Cash or Credit
      Enters amount given to room
   Passes PINPad to customer
      Customer enters own unique four digit PIN password
      Customer presses enter key, and returns PINPad to front desk
      Room account is created for customer in system
   2 receipts will be printed at this time. The guest will sign one of the copies, which is then put into in the room folio at the desk. The other is given to the customer. The receipts contain the disclaimer.

The POS will contain an employee privileges database, which will allow certain rights. Different rights/privileges are given to employees using the system. For example: Supervisors are allowed to enter up to $5000.00, staff can enter up to $1000.00.

(Check-in could be done at an automated or non-automated kiosk, casino/desk location, or from the room. Credit cards as well as cash can be accepted to open this account. Once money is placed into the account (attendant accepts, automated money entry, credit card acceptor), the customer must create a unique Password/PIN value for play. This is done using either a keyboard, numeric keypad (tethered/wireless), touchscreen (resistive, capacitive, or proximity), TV remote, or any other device that can be used to enter this value. The system can take the first entry, or ask the customer to enter again for verification. A room key or player tracking card could also be used, since the system can be connected to both the casino accounting system, player tracking system, as well as the hotel system.)

Customer check out:

Front desk checks folio to see if system was played.

If ‘YES’, goes to the POS (located at Casino Cash Cage):
Goes to checkout on POS (located at Casino Cash Cage)
Enters room number to check out
Customer enters PIN password on PINPad to authenticate use
Room report is printed

When a customer checks out a report from the system is printed out for room activity. Two copies will be made, one for the customer and one for the casino/front desk. Any charges would be paid by the customer and a receipt given. For credits due to a customer, the copy given to the customer would be used as a receipt.

(The customer can check-out of the system or withdraw funds from the account at any time. The Password/PIN value would be entered using the above choices, and once this is verified the money can be removed. This can be done by an attendant handing out money, or an automated system giving out money or a ticket. Current ticket-in/ticket-out technology can be used for these tickets. In locations where TITO is not available, the location can create their own ticket system so that the customer goes to a cash cage to receive money. One method used has two printouts created. One is signed by the customer and placed in the customer folio. The customer then goes to the cash cage, which can verify this paper with the front desk to ensure payment is really due. A sequence number is placed on this paper so internal auditing can make sure no paperwork is missing.)

PROCESSES

Check-In/Enrollment Process

The ‘Check-In/Enrollment’ selection allows a new player to open an account.

The process follows these steps:

### 1. Operator Enters User ID and Password ID to Enter Check-In/Enroll Screen.

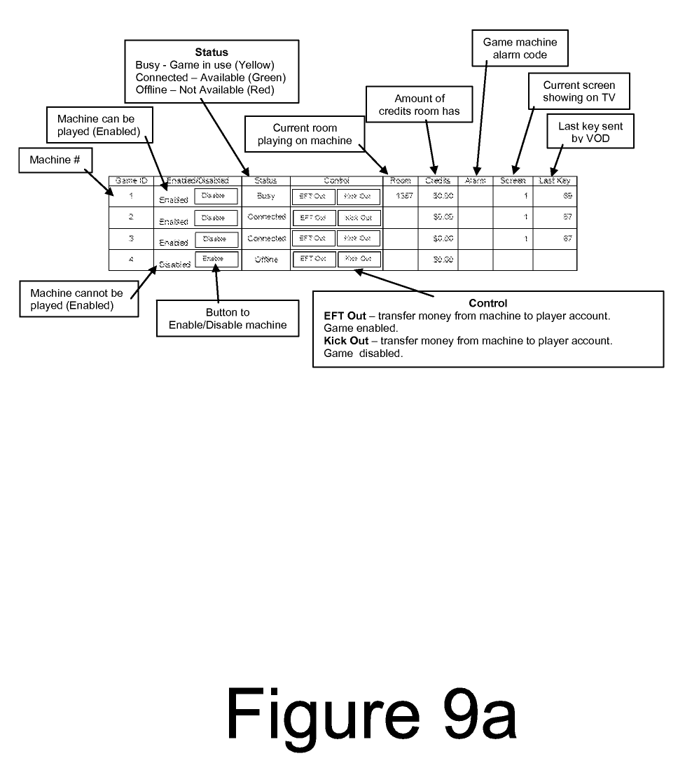

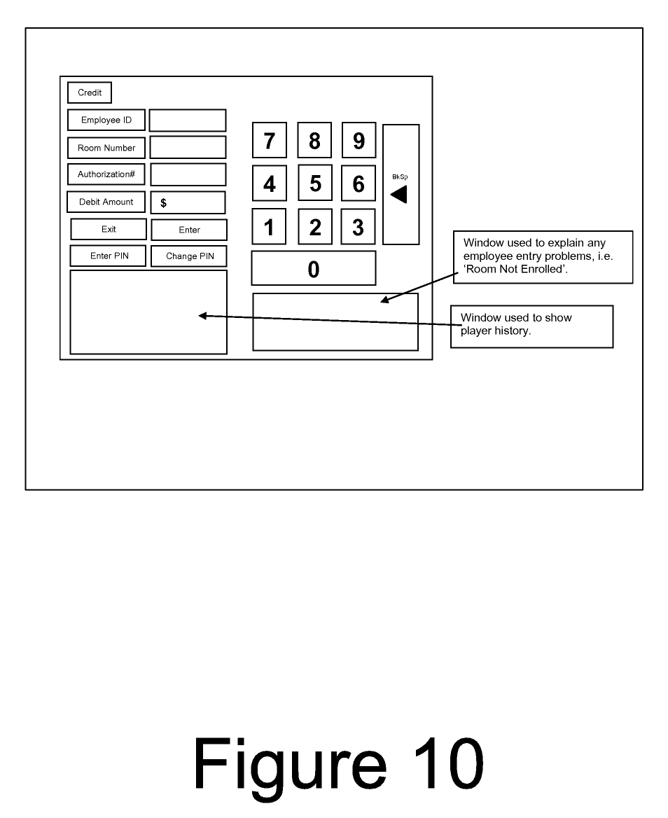

The system verifies that these entries are correct and what type of entries this person is allowed. Examples of this include: Administrator—Cannot Check-in. Supervisors—Maximum money amount $5,000.00. Staff—Maximum money amount $1,000.00. If the entries do not match an entry in the database, the system asks for another entry. The administrator is allowed to set up these privileges. The Check-In/Enroll screen appears as in FIG. 10.

### 2. Operator Enters Room Number.

System checks to make sure the room number is in the min-max acceptable range. If not then the operator is told to enter another room number. The min-max values are contained in a configurable file, and can also be included in the database.

System checks to make sure the accepted room number is available. If it is previously enrolled, then the operator is told the room has already been enrolled, and must enter a different room number. If the room is not enrolled, then it is accepted.

### 3. Operator Presses the Cash/Credit Button.

The system marks the money taken from the customer as either from cash or credit card use. If a credit card is used, the authorization number is entered. If a cash entry is made, then the system will only allow a given amount into the account per 24-hour period. This value is contained in a configurable file.

### 4. Operator Enters the Money Amount.

This is taken as correct currency for the given location.

### 5. Player Enters Unique PIN Password.

This entry can be done with a numeric PINpad, keyboard, voice, biometrics, room card, player tracking card. The password can be a numeric number, alpha-numeric, or read from the card read thru the mag reader. The system contains configurable files that have minimum lengths for acceptable values. The system can ask for this to be done twice to ensure the entry is correct.

The operator could hand this device to the player for entry or it could be built into the unit.

If a second entry is made, the system makes sure both entries are the same. If the entries do not match, the player is told they do not match and must do this procedure again.

### 6. Player Account is Created.

All money is placed into an account for the player when using the system.

Each player account is unique, and can only be used by this player. The system takes the unique PIN password along with other methods to create a unique account number. This could include taking the room number, room TV ID, and PIN password, or even be created by a RNG inside the system for a unique value to add to the PIN password. Biometrics could also be used to create this unique account since a biometric can be changed to a unique value.

Two receipts of this transaction are printed out. This receipt includes a disclosure to the player that can explain the following examples:
This is real gaming for real money
You agree you the legal gaming age
How malfunctions and complaints are taken care of
Printout is contained in a configurable file
Location for employee to sign
Location for player to sign
Location for date to be printed
Amount of money placed into account
Time/date account has been opened
If applicable, room number that contains this account

Player and operator sign all copies, with player given one copy and operator keeping another copy.

If the casino requires, a copy of the player driver's license, passport, and/or SS# can be copied and placed with the signed copy kept by the operator

The system will use this account for all account transactions.

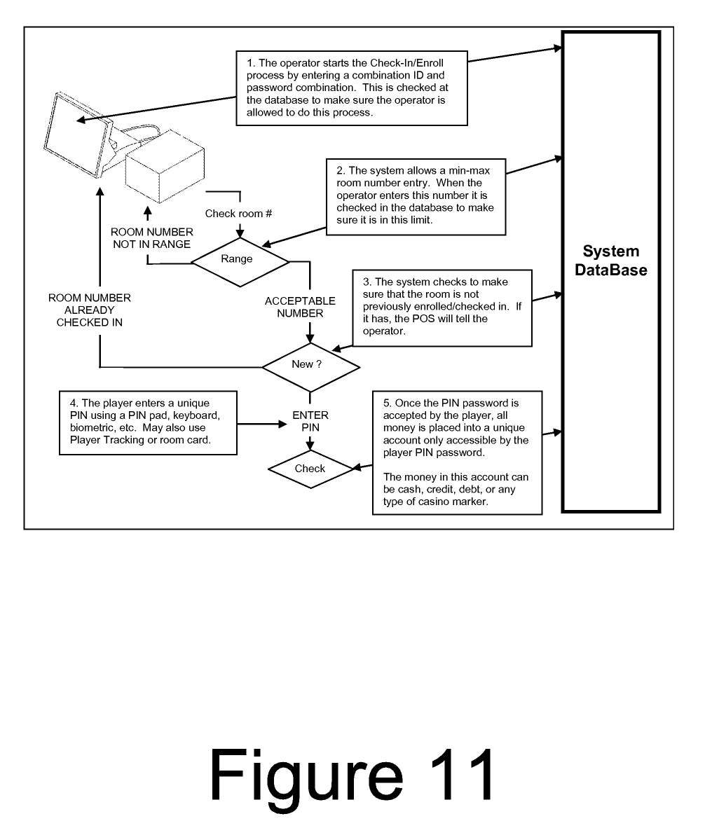

See FIG. 11 for a flow diagram of the Check-in/Enroll procedure.

Add Money Process

The ‘Add Money’ selection allows money to be added to a previously enrolled room. The process follows these steps:

1. Operator enters User ID and Password ID to enter Add Money Screen.

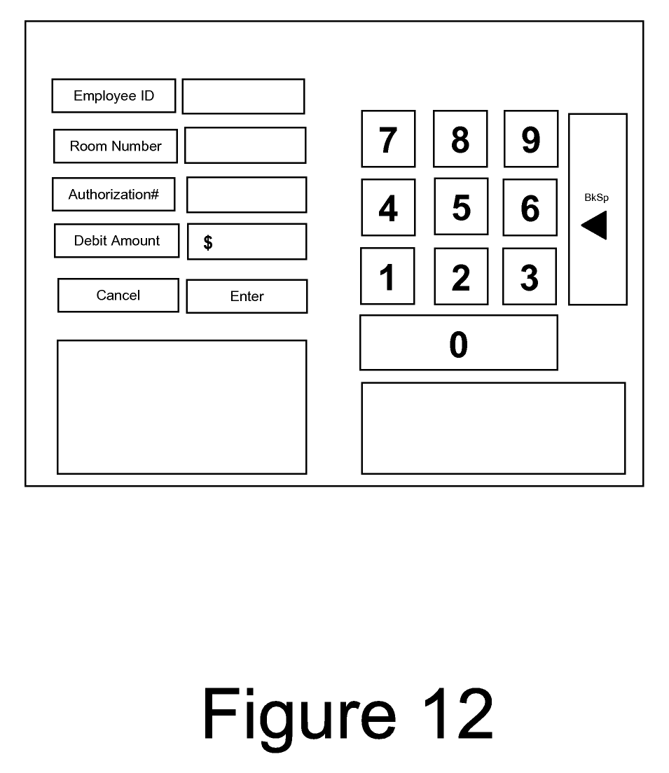

The system verifies that these entries are correct and what type of entries this person is allowed. Examples of this include: Administrator—Not allowed. Supervisors—Maximum money amount $5,000.00. Staff—Maximum money amount $1,000.00. If the entries do not match an entry in the database, the system asks for another entry. The administrator is allowed to set up these privileges. The Add Money screen appears as in FIG. 12.

2. Operator enters room number.

System checks to make sure the room number is in the min-max acceptable range. If not then the operator is told to enter another room number. The min-max values are contained in a configurable file, and can also be included in the database.

System checks to make sure that the room is enrolled, meaning money can then be placed into the account. If the room is not currently enrolled, the operator must enter another room number.

System checks to make sure that the room entered is not currently playing on the system. Money can only be entered into an account that is currently idle, meaning not in use. If the entered room number is currently in use, the operator must enter a different room number.

3. Operator enters the money amount.

This is taken as correct currency for the given location.

4. Added money is placed in account.

The amount entered from #3 is added to any money currently in the account. This new amount is now available in the player account.

Inquiry Process

The ‘Inquiry’ selection allows the operator to view different data reports. The process follows these steps:

1. Operator enters User ID and Password ID to enter Inquiry Screen.

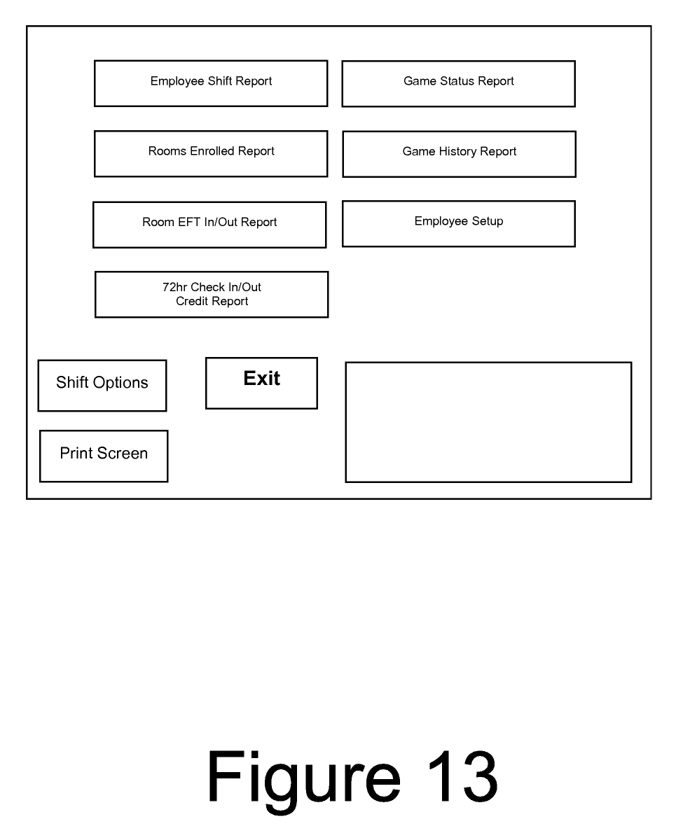

The system verifies that these entries are correct and what type of entries this person is allowed. Different levels are allowed different reports. The Inquire Screen appears as in FIG. 13. They are set up as follows, and are configurable:

Administrator level will be allowed:

Employee Shift Report—Shows all activity of the different employees during a shift. The Administrator is allowed to print all Employee shifts, while a Supervisor or Staff will only show their information.

Room EFT In/Out Report—Shows all EFT activity for all rooms. Includes:
EFT In—Money put on the slot machine from the room account
EFT Out—Money taken off the slot machine and put into the room account
Transaction #—Transaction number generated from the database for each money transfer
Time/Date—Each time a transaction occurs, the date/time is placed in the database
Game ID—The number of the game for each transaction
Total In
Total Out
Net Hold
Player tracking points accumulated

72 hr Check In/Out Credit Report—Shows all activity for all rooms enrolled in the system for the last 72 hours. Includes:
Room #—Room number
In/Out—Room checked in or out during this time
Type—The room checked in as either a cash or credit transaction
Amount—Amount of money placed into the room. This is either cash/credit
Auth ID—Authentication ID from credit card company
Date/Time—Date/Time the room checked into the system

Rooms Enrolled Report—Shows all rooms currently enrolled in the system. Includes:
Room—Room number enrolled
Date/Time—Date/Time of enrollment
Current Balance—Current room balance

Game Status Report—Shows the status of all games in the system. The status of a game is as follows:
Busy—Yellow. The game is in use
Out—Red. The game is currently off
Available—Green. The game is available for play
See FIG. 9.

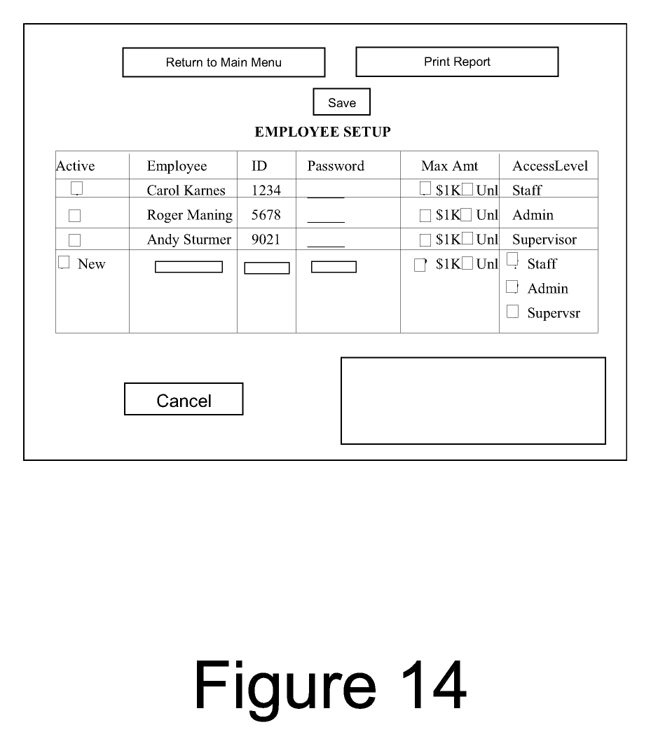

Game History Report—Shows the history for all games in the system. The following is available:
Game
Session
Coin In
Coin Out
Date/Time
Games Played
EFT In
EFT Out
Current Credits
Room
Employee Setup—Allows the administrator to enter employee User ID, PIN ID, and type. See FIG. 14.

Supervisor and Administrator level will be allowed:
Employee Shift Report
Room EFT In/Out Report
72 hr Check In/Out Credit Report
Rooms Enrolled Report

All employees will be allowed:
Employee Shift Report
Rooms Enrolled Report

Room number can be replaced with a player tracking ID number or customer ID number.

Game Play Process

This explains how play is made on the TV. The process follows these steps:

1. Player turns on TV.

The TV is turned on using a remote. The movie system shows a menu which will include ‘gaming’ as one of the choices. This number is picked with the remote device.

2. System checks if any gaming machines are available.

Movie system communicates to the system that a player is asking for a game. The Traffic Manager checks to see if any machines are available. There are two responses:
No Games available. The Traffic Manager reports to the movie system that all games are currently in use. The movie system will tell the player that no games are available.
Game available. The Traffic Manager reports to the movie system that a game is available. The movie system communicates the room number to the Traffic Manager to make a connection.
   3. Traffic Manager checks if room is enrolled in the system.

The Traffic Manager checks the database to see if the room number communicated from the movie system is currently enrolled. If it is not enrolled, a screen appears on the TV to tell the player they are not part of the system, and then returns them to the original movie system screen. An example of this screen appears in FIG. 15.

4. Traffic Manager checks if money is in the player account.

The Traffic Manager checks the player account to see if there is any money for game play. If there is no money, a screen appears on the TV informing the player they have no money. The system then returns them to the original movie system screen. An example of this screen appears in FIG. 16.

5. Enter PIN password.

The PIN password is entered with the remote device. A biometric device could be part of the remote device to allow this type of password entry. To use a player tracking card or room card a mag reader could be included on the remote device or on the TV/movie box. An example of this screen appears in FIG. 17.

Once the PIN password is entered the system checks the database to see if there is a match for this player. A configurable amount of tries are allowed to get this entry correct, and if this does not occur in this amount the player is removed from the system and taken back to the original movie system screen. See FIG. 18.

6. Money is transferred to game machine.

The player account is electronically transferred from their player account onto the game machine. The player uses the remote device to play the game(s) shown on the screen. The remote device mimics game button presses by taking a selection and pressing the correct game function. See FIG. 1.

During game play the operator can check the status of the games by looking at the POS main screen. Buttons on the main screen represent each game and show in real- time how each game is performing. See FIG. 8a-FIG. 8d.

### 7. Finish Game

When the player presses the ‘EXIT/QUIT’ button the system verifies that all games are finished playing. The player may be in the middle of a poker or blackjack hand, for example. The system shows a screen to notify the player of this. See FIG. 20.

### 8. No Activity Timer

If the player does not make any type of selection with the remote device for a configurable time, than the system will automatically remove any money from the game and place this into the player account. The player can return to the system by following the previous steps. See FIG. 19.

If the player is in the middle of a game when the time-out occurs, the system will automatically finish the game and remove any money from the machine and place into the player account.

### 9. Exit the Game

When the player is ready to exit the game, press the ‘QUIT/EXIT’ button on the remote device. A screen will explain how much money is left for deposit into the player account. The next time the player enters the system, this money amount will be transferred back onto the device. See FIG. 21.

The movie system screen will appear on the screen.

A flow diagram of game play can be found in FIG. 22.

Check-Out Process

The ‘Check-Out’ selection allows a player close an account and receive any payment due.

The process follows these steps:

1. Operator enters User ID and Password ID to enter Check-out Screen.

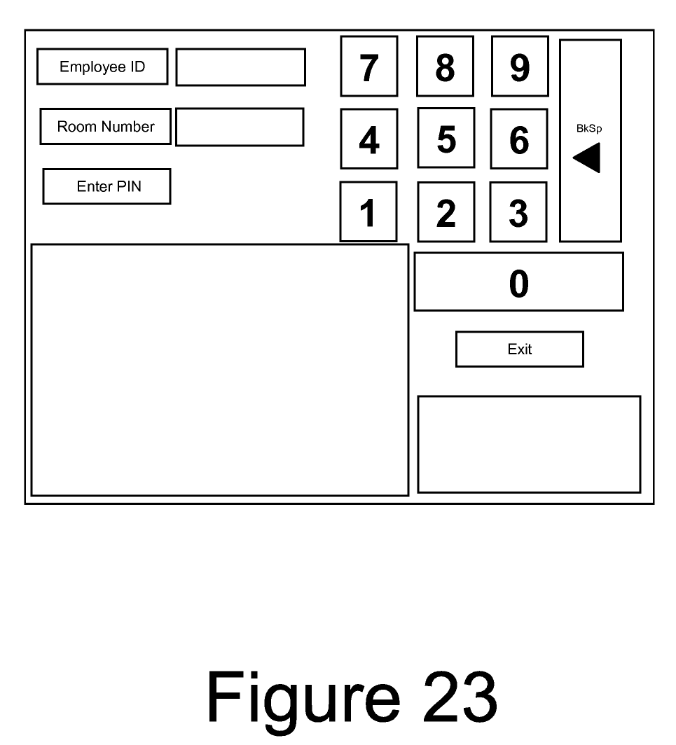

The system verifies that these entries are correct and what type of entries this person is allowed. Examples of this include: Administrator—Cannot check-out. If the entries do not match an entry in the database, the system asks for another entry. The administrator is allowed to set up these privileges. The Check-Out screen appears in FIG. 23.

2. Operator enters room number.

System checks to make sure the room number is in the min-max acceptable range. If not then the operator is told to enter another room number. The min-max values are contained in a configurable file, and can also be included in the database.

System checks to make sure that the room is enrolled, meaning money can then be placed into the account. If the room is not currently enrolled, the operator must enter another room number.

System checks to make sure that the room entered is not currently playing on the system. Money can only be entered into an account that is currently idle, meaning not in use. If the entered room number is currently in use, the operator must enter a different room number. System checks to see if room number entered is currently enrolled in the system. If it is not the operator is asked to enter another room number.

3. Player enters unique PIN password.

This entry can be done with a numeric PINpad, keyboard, voice, biometrics, room card, player tracking card. The password can be a numeric number, alpha-numeric, or read from the card read thru the mag reader. The system contains configurable files that have minimum lengths for acceptable values. The system can ask for this to be done twice to ensure the entry is correct.

The operator could hand this device to the player for entry or it could be built into the unit.

If a second entry is made, the system makes sure both entries are the same. If the entries do not match, the player is told they do not match and must do this procedure again.

4. Player account is closed

Two receipts of the player account activity and payment due are printed. This receipt includes the following:
You agree you the legal gaming age
Printout is contained in a configurable file
Location for employee to sign
Location for player to sign
Location for date to be printed
Amount of money due the player in numeric, alpha-numeric, and bar-code form
Time/date account has been closed
If applicable, room number that contains this account
Sequential numbering system, configurable by file
Player tracking points accumulated

Player and operator sign all copies, with player given one copy and operator keeping another copy.

Operator can give player money due at this location or to a cash out location with the receipt.

When receipt is given to cash out location, can be checked by either calling first location or using a bar-code reader type system to mark the database as paid.

Room number is now cleared for another player to use.

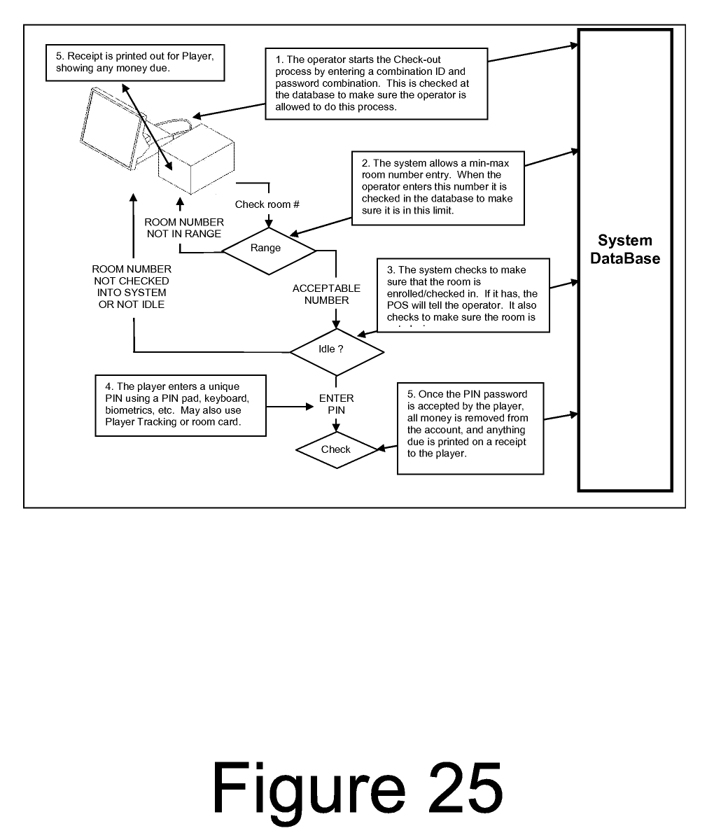

See FIG. 25 for a flow diagram of the Check-out procedure.

See FIG. 2 and FIG. 26 for the system overview diagrams.

As inferred above, the foregoing implementations are not the same as going to an internet casino; this is actual casino gaming using the movie/web based system, TV and the TV remote (or some type of remote). Actual Class II and Class III machines used today and downloadable/server-based machines can be used. The front desk/casino/kiosk (automated or non-automated) would place money into the room account for play. The checking in process as well as the checking out process is unique.

In summary, the disclosed implementations are enabled for:

Use of movie system or web-based system to play real slot (gaming) machines for real money; including class II, class III, downloadable, server-based, and system-server based gaming. This play is allowed wherever the TV/movie/web-based system is operating.

Use of a movie/web-based system as a portal for a remote gaming system

Use of a TV remote for gaming

Use of a remote device to play a TV for gaming

Using biometrics on a remote device to authenticate a player for movie/web-based gaming

Using a room card on a remote device to authenticate a player for movie/web-based gaming

Using a player card on a remote device to authenticate a player for movie/web-based gaming

The ability of the remote device to be two-way including game feedback such as lights, sounds and vibrations to emulate the casino floor.

At check in and in-room to provide the ability to have a small digital camera record the user for verification.

The remote device having an authentication method, whether or not encrypted, which enables the movie/web-based system to verify the remote device when communication occurs. This verification can occur for all communication or timed. If it is not verified play is not allowed.

The remote device having an authentication method, whether or not encrypted that can be ported through the movie/web-based system directly to the gaming system to verify the remote device when communication occurs. This verification can occur for all communication or timed. If it is not verified play is not allowed.

Rack mounting of gaming machines

Can use any manufactures game so the user has access at the remote location to choose the game of their choice.

The remote can be IR or RF technology

System can be built into the actual TV using the “smart port” technology on almost all hospitality TV's.

An electronic system for gambling by casino players. The system allows an authorized player to operate an electronic gaming system's game board from a remote location, and does so in a way that will be acceptable to regulatory bodies, by meeting requirements of applicable gaming laws and regulations.

Networking/scalability of gaming machines

Gaming as a choice on a TV movie system menu

Ability to have a casino without needing casino floor space

Ability to have the remote gaming system anywhere the cable TV system passes including pool side cabanas, restaurants, bars even the casino floor.

The ability to offer at one single location tied to the system, a suite of casino games from substantially all significant game providers so the customer can select their favorite game.

Play on any TV that is connected to the movie/web based system without wiring

Play remote gaming in a cabana/pool location with the TV and a remote device

Opening a customer account that can be electronically accessed for gambling. This includes adding money as well as removing money from this account.

Check-in process:

When a customer wants to play, an account must be created. This can be done at an automated or non-automated kiosk, casino/desk location, or from the room. Credit cards as well as cash can be accepted to open this account. Once money is placed into the account (attendant accepts, automated money entry, credit card acceptor), the customer must create a unique Password/PIN value for play. This is done using either a keyboard, numeric keypad (tethered/wireless), touchscreen (resistive, capacitive, or proximity), TV remote, or any other device that can be used to enter this value. The system can take the first entry, or ask the customer to enter again for verification. A room key or player tracking card could also be used, since the system can be connected to both the casino accounting system, player tracking system, as well as the hotel system. A digital photo may be taken or biometric reading to verify the customer's access.

Credit cards as well as cash can be entered since the money is removed from player account

For disclaimer purposes, a set number of printouts are created, one signed by the customer and placed in the customer/room folio and the other given to the customer. On this paper can be written any disclaimers the location requires, so the customer knows this is real money/real gaming.

Adding Money:

A customer can add money to the account by visiting any of the above locations, enter the correct password/PIN value, and place more money into the system.

Check-out/Withdraw process:

The customer can check-out of the system or withdraw funds from the account at any time. The Password/PIN value would be entered using the above choices (or biometric and digital camera image), and once this is verified the money can be removed. This can be done by an attendant handing out money, or an automated system giving out money or a ticket. Current ticket-in/ticket-out technology can be used for these tickets.

In locations where Ticket-In-Ticket-Out (TITO) is not available, the location can create their own ticket system so that the customer goes to a cash cage to receive money. One method used has two printouts created. One is signed by the customer and placed in the customer folio. The customer then goes to the cash cage, which can verify this paper with the front desk to ensure payment is really due. A sequence number is placed on this paper so internal auditing can make sure no paperwork is missing.

Real-time status button

Tells the status of each gaming machine, constantly being updated. Includes the following data:

Game available/unavailable. Game disabled (by Traffic Manager or communication error). Game in play (showing room using and current room account). Pressing button gives real time meter readings

Button to allow release of gaming machine from room

Automated timer for release of gaming machine if not used for a certain time interval. Any remaining money will be placed in player's account.

Testing of game to ensure that player has finished a game. If not, a screen will remind them.

Automated finish of game if no play for a certain time interval. If the game is in the middle of play the system will automatically finish this play and put remaining money in player's account.

System tests to see if player has an account and if not does not allow them to enter.

When a player's account reaches $0.00, automate release of the gaming machine.

Method to enter the PIN password into the system and verify this is correct. If not, play will not be allowed. The player is allowed x tries before being removed from the system.

Allow tickets to be placed into a kiosk or front desk bill validator and transferred into the player account as money.

A button on the remote device to view current player points, either on the remote device or on the TV.

Ability to enter credit card number using the remote device into the system and have it verified, then transferring the money to the player account.

Ability to play gaming machine and use Picture In Picture (PIP) to watch television, including Pay Per View movie.

Ability to play gaming machine, PIP, and sports betting on one TV with a single remote device.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A hospitality facility having a user terminal that allows a user to use an input device to select a movie and an interactive video game to play on a display screen, wherein the hospitality facility is remote from a gaming device configured to run an interactive casino game and to track the amount of winnings and losses for each play of the interactive casino game, a traffic manager remote from the hospitality facility, the hospitality facility comprising:
means, remote from the hotel room, for receiving a transmission from the user terminal containing the selection of the user in the hotel room of the movie, the interactive video game, and the interactive casino game for display on the display screen in the hotel room;
a processor; and
memory containing instructions which, when executed by the processor, performs a method comprising the steps of:
receiving, with the receiving means, the transmission from the user terminal containing the selection of the user in the hotel room of the movie, the interactive video game, and the interactive casino game for display on the display screen in the hotel room, wherein when the input from the a user of the user a terminal is the selecting of a the interactive casino game to play on the user said terminal;
displaying said casino game on said display screen;
receiving the input from said user of said user terminal via said input device selecting the interactive casino game to play on the user terminal;
searching a table to determine an action said user of said user terminal selected to be performed in said casino game using said input via said input device from said user of said user terminal;
forming a transmission, containing said action to be performed in said casino game, addressed to a processor of the a gaming device;
receiving from said gaming device a next screen to be displayed on the display screen to said user in said casino game after said user's selected action is performed; and
transmitting to said user terminal said next screen to be displayed to said user on said display screen.

2. In a hospitality environment including a hotel room that is remote from an entertainment system that allows a guest in the hotel room to use an input device to select a movie or an interactive video game to respectively play on a display screen in the hotel room, wherein the hotel room is remote from a gambling device configured to run an interactive casino game and to track the amount of winnings and losses for each play of the interactive casino game, an in-room and/or remote gaming system in-room and/or remote gaming system comprising:
a user terminal in communication with the display screen and the input device; and
a communication port in communication with the user terminal and a traffic manager, wherein:
the traffic manager is remote from the hotel room and in communication with:
the entertainment system; and
the gambling device;
the user terminal receives input from the guest on the input device that is a request to play one of:
the interactive casino game;
the interactive video game; and
the movie;
the communication port addresses a transmission to the traffic manager containing the request to play that was input by the guest using the input device;
the guest's request to play corresponds to a display for displaying on the display screen; and
the user terminal receives a transmission through the communication port addressed from the traffic manager and containing the display for displaying on the display screen that corresponds to the guest's request to play.

3. The in-room and/or remote gaming system in-room and/or remote gaming system as defined in claim 2, wherein the input device is selected from the group consisting of a keyboard, a remote control and a combination thereof.

4. The in-room and/or remote gaming system in-room and/or remote gaming system as defined in claim 2, wherein the input device can be used by the user to select: each of a plurality of:
each said interactive casino game from a plurality thereof;
each movie from a plurality thereof; and
each said interactive video game from a database of Personal Computer (PC) games.

5. The in-room and/or remote gaming system in-room and/or remote gaming system as defined in claim 2, wherein the interactive casino game comprises one or more interface boards in communication with the traffic manager.
